(19) United States
(12) Patent Application Publication
(10) Pub. No.: US 2005/0206967 A1
(43) Pub. Date: Sep. 22, 2005

(54) Method and system for managing modality worklists in hybrid scanners

(75) Inventors: Lavanya S. Viswanth, Bangalore (IN); Yahya I. Kammukutty, Calicut (IN)

Correspondence Address: Carl B. Horton;GE Medical Systems, Global Technology Company, 3000 N. Grandview Blvd, Waukesha, WI, 53188, US

(73) Assignee: General Electric Company

(21) Appl. No.: 10/805,567

(22) Filed: Mar. 19, 2004

(51) Int. Cl. G21K 1/12; G06F 17/00

(52) U.S. Cl. 358/474; 358/448

(57) ABSTRACT

A method and system for integrated modality worklists management for hybrid scanners is disclosed. The present invention retrieves schedules of multiple modalities in a hybrid scanner in response to a single action by the operator of the hybrid scanner, thereby improving operator efficiency. The retrieved schedules are collated and stored in a common database. The automated maintenance of a common database improves data integrity.

### FIELD OF THE INVENTION

The present invention relates to the field of medical diagnostic and imaging systems. More specifically, the invention relates to modality worklists management in hybrid scanners.

### BACKGROUND OF THE RELATED ART

There are a number of well known non-invasive imaging techniques for the diagnosis and treatment of patients. These techniques are used to obtain high-quality images of the human anatomic structure. The images are obtained using scanners that are based on multiple facets of medical imaging technology. These images provide useful diagnostic information for treating medical ailments.

Currently, a number of member technologies (a.k.a. modalities) exist for medical diagnostic and imaging systems. These systems include, without limitation, computed tomography (CT), X-ray, magnetic resonance (MR), positron emission tomography (PET), ultrasound, and nuclear medicine. When a patient's anatomical structure, or a limb thereof, is scanned using technology from one of these modalities, that portion of the patient's anatomy is imaged. The resulting anatomic image can be stored in an imaging database for later use.

In addition to storing images internally, the imaging systems need to be able to transfer images to various types of remote devices via communication networks. This requires that the data transferred by the imaging system be in a format, which is supported by the destination remote device. This is achieved by application layer standards such as DICOM (Digital Imaging and Communications in Medicine).

The DICOM standard is intended for use in communicating medical digital images among printers, workstations, scanners (i.e., CT-scanner, MRI scanner, PET scanner) and file servers. The DICOM standard facilitates communication of digital images of different types such as X-ray, CT, MR, and ultrasound images. The technology of each modality is programmed to transfer data in a format, which complies with the DICOM standard. Similarly, the destination remote device is programmed to receive data, which complies with the DICOM standard.

The fundamental concept employed in DICOM is “Services on Objects”. One example of an “Object” is an ultrasound image. Examples of a “Service” are the “Store” and “Query/Retrieve” functions. In DICOM, methods of operating on information objects are referred to as “Service Object Pair Classes” (SOP Classes). Examples of SOP Classes are “Store an ultrasound image”, “Print an ultrasound image”, “Find which studies there are for a certain patient”, “Retrieve all studies of a certain patient” and “Retrieve a worklist”.

The DICOM communication system is based on a client-server architecture that uses the above-described concept. The device using a service (on objects) is the client device, while the device providing the service is the server device. The client device is referred to as a Service Class User (“SCU”), while the server device is referred to as a Service Class Provider (“SCP”). The SCU sends a service request to the SCP over a network. The SCP sends back a response to the SCU over the same network. If the response is affirmative and a common communications protocol is agreed upon, an association between the SCU and the SCP is opened and data can be transferred between the two devices. In the DICOM system, a device can be both SCU and SCP at different times.

Apart from digital image transfer, DICOM is also used for functionalities such as media storage, print management, and modality worklist management. These functionalities involve communication between the imaging system and Hospital Information System (“HIS”)/Radiology Information System (“RIS”) to answer patient related queries.

Communication between the imaging system and the HIS/RIS needs to be optimized for maximum time use of the imaging system. This optimization is achieved using modality worklist management. Modality worklist management is used for managing the information regarding patients and their schedules for scanning. This involves retrieval of a worklist from HIS/RIS at a hospital via the communication network. The worklist has schedule information regarding patients to be examined within a particular time range using a particular imaging system. This schedule information may include certain patient demographic information: (e.g., name, identification number, gender, birth date, accession number, date and time of scan, procedure description, etc.).

Modality worklists management maximizes the utilization of the scanner time. This is made possible by procuring the available patient and scheduled procedure data from the HIS/RIS before the scan time. Modality worklist management also ensures maximum utilization of scanner time by centralizing the scheduling of the modalities in the hospital. Modality worklist management also prevents inconsistent workflow in the hospital network by eliminating multiple data entry points, such as that at HIS and at the modality.

The typical workflow of modality worklist management is initiated by a query from a modality to the remote HIS/RIS. The HIS/RIS is queried using parameters such as date range and type of modality. In response to the query, the patient demographic data and exam data (such as Schedule procedure step ID) are retrieved. Based on the patient demographic data and exam data, appropriate protocol is also selected for the scan. The demographic data, exam data and protocols are then transferred to the scanner system to initiate scanning.

A typical modality worklist for patient management application comprises a patient scheduler, worklist server and a schedule database. The worklist server acts as the SCU for the communication between a modality and the HIS/RIS. The queries for retrieval of the worklist are sent from the worklist server to the HIS/RIS through the patient scheduler. The patient scheduler triggers the queries and manages the schedules for efficient utilization of scanner time. In response to the queries sent through the patient scheduler, the worklist corresponding to the query is sent by the HIS/RIS. This worklist is then saved on to the schedule database. Further, it is also transferred to the relevant modality through the patient scheduler for further processing.

The modality worklist management application described above is used for a conventional scanner based on a single modality such as MR, CT, or PET. A new development involves the use of hybrid scanners such as PET-CT combined scanners. Hybrid scanners provide independent services for each modality involved, in addition to providing value-added combined services. For example, a PET-CT hybrid scanner allows the imaging of a particular location of the patient body using both the PET and the CT technology. The images obtained using the two modalities, can be correlated to obtain valuable information, such as a more precise location of injury or ailment.

The advent of such hybrid scanners also requires corresponding changes in the modality worklist management system. Currently, in a hybrid scanner, each modality has its own independent worklist management system. For example, in a PET-CT hybrid scanner, the CT system has a modality worklist management application that has a patient scheduler and a worklist server. This application takes care of worklist/schedule management on the CT side of the system. Similarly, the PET system has a separate modality worklist management application that has its own patient scheduler and worklists server.

The existing worklists management system for a hybrid scanner has duplicate applications. This duplication reduces operator productivity, as the operator has to query the same schedule for both the modalities. Therefore, more user actions are required to obtain the worklists for a hybrid scanner. Further, as the worklists of different modalities are maintained in different databases, it is difficult to identify whether a hybrid procedure is requested or a stand-alone procedure involving one or both of the modalities. Such identification requires accessing the worklist of each modality and comparing the schedule entries contained therein to identify a request for a hybrid procedure. Further, a single modification in the schedule needs to be updated in both the databases, thus storing the worklists of the all the modalities in the hybrid scanner. Thus, reflecting a single change in schedule requires multiple update operations leading to diminished data integrity. Additionally, the current DICOM protocols allow only a single modality in a query. Hence, it is not possible to have a query that is associated with multiple modalities, as is typically the case while using hybrid scanners. This reduces the productivity of the hybrid scanners and limits their applications.

Hence, there is a need for a system that improves the operator productivity by using an integrated workflow system to manage the schedule for all the modalities in the hybrid system. The system should have a field configurable and customizable patient scheduler and worklists server. Further, the system should allow for retrieval of schedules from the HIS/RIS for multiple modalities corresponding to a single query (or in response to a single user action). Upon implementation, the system will experience improved data integrity, which eliminates the need to update multiple schedules for the same patient.

### BRIEF SUMMARY OF THE INVENTION

The present invention is directed to a method and system for managing modality worklists for hybrid scanners, while providing support for single modality scanners. The integrated modality worklists management provides for sequential querying of the HIS/RIS server for the schedules of multiple modalities, and saving the responses to these queries in a common database. The common database ensures data consistency between the schedules of the multiple modalities in the hybrid scanner. The present invention can be configured for use with all single modality scanners as well as hybrid scanners. This is achieved by providing support for any user-defined combination of modalities in a hybrid scanner. Further, the present invention allows the user to specify the “Modality” name field as defined by DICOM for each modality of a hybrid scanner. This enables queries for any modality to be sent to the HIS/RIS server.

For performing the scan requested in the schedule entry, the schedule entry is mapped to a scan protocol. The scan protocol for a scanner is a scan prescription that contains all the details related to a scan. The scan protocol is further mapped to Action Item Codes (AICs) that are specific to the scanner being used. (AICs refer to a list of activities that need to be performed for the particular scan by the modality). The present invention functions with all hybrid scanners by allowing the operator of a hybrid scanner to configure the protocol to AIC mapping using AICs for any scanner.

In one embodiment, there is provided a method for performing integrated modality worklist management. The method includes obtaining the set of modalities of interest, automatically retrieving the schedule for each modality in the set from the HIS/RIS server, and collating the schedules retrieved to obtain an integrated modality worklist. The integrated modality worklist is preferably maintained in a common database to improve data integrity.

In another embodiment, there is provided a system for retrieving and storing scheduling information for multiple modalities. The system includes an integrated patient management application and a common database. The integrated patient management application retrieves schedule information for multiple modalities in response to one or more requests made by the operator of the hybrid scanner. The schedules retrieved are collated and stored in the common database. The common database stores the schedules for multiple modalities, thus eliminating the need for maintaining separate databases for each modality. This leads to improved data integrity, as any change in the schedule of a hybrid scan has to be updated only in one common database, and data conflicts between multiple databases are avoided.

### BRIEF DESCRIPTION OF THE DRAWINGS

The various embodiments of the present invention will hereinafter be described in conjunction with the appended drawings, which are provided to illustrate an exemplary embodiment and assist in understanding the invention but not to limit the present invention, wherein like designations denote like elements, and in which:

FIG. 1 is a block diagram of the environment in which the present invention works.

FIG. 2 is a flowchart showing a method of retrieving schedules for the modalities of interest from HIS/RIS server.

FIG. 3 is a graphical user interface (GUI) provided by Integrated Patient Scheduler for viewing and editing a common database and for configuring Integrated Patient Scheduler.

FIG. 4 is a GUI to edit the user-defined preferences that control the retrieval of schedules from HIS/RIS server.

FIG. 5 is a GUI for the configuration of Integrated Patient Management Application.

### DETAILED DESCRIPTION OF EXEMPLARY EMBODIMENTS

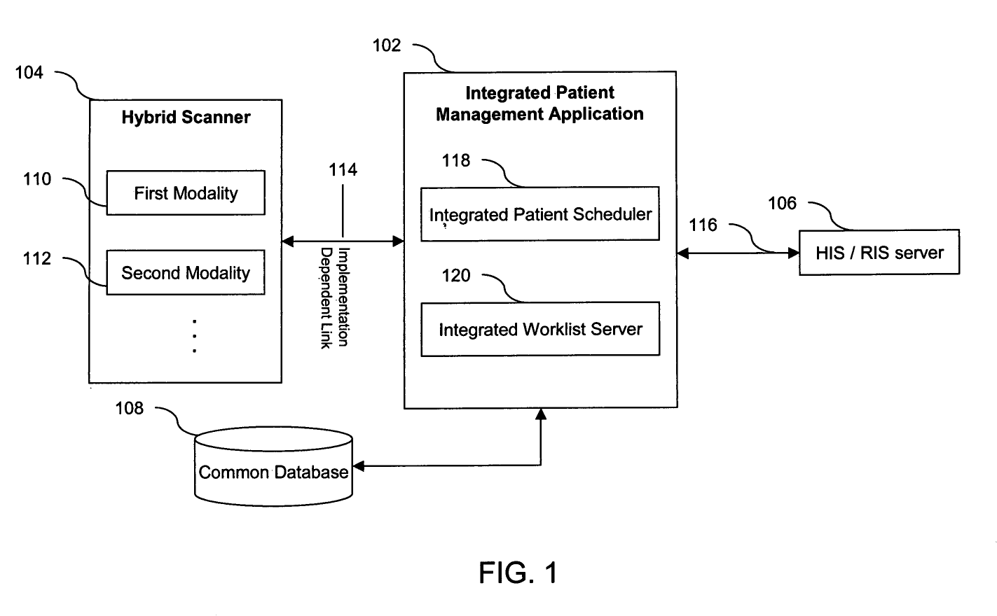

Referring to FIG. 1, a block diagram of an environment in which the present invention works is hereinafter described. FIG. 1 shows an Integrated Patient Management Application 102 that performs modality worklist management for Hybrid Scanner 104 using schedule information obtained from a HIS/RIS server 106. Hybrid Scanner 104 comprises a combination of two or more modalities for performing various regular scans using a single modality, as well as hybrid scans using a combination of two or more modalities. Hybrid Scanner 104, shown in FIG. 1, has two modalities—a first modality 110 and a second modality 112. The example of a hybrid scanner with two modalities is used only as an illustrative example, and is not intended to limit the scope of the present invention. It will be apparent to one skilled in the art that the present invention will provide support for any desired combination of modalities, regardless of whether they are located in a single Hybrid Scanner 104 or a multiple scanner equivalent of such. Some examples of the modalities of Hybrid Scanner 104 include without limitation: a CT scanner, a PET scanner, an MR scanner, an ultrasound scanner, a X-ray scanner, and a gamma camera.

The communication between the modalities of Hybrid Scanner 104 and Integrated Patient Management Application 102 is established through an Implementation Dependent Link 114. In one embodiment of the present invention, Implementation Dependent Link 114 is a TCP/IP socket based communication. However, it should be apparent to one skilled in the art that the communication need not be limited to TCP/IP socket based communication. Further, the communication between HIS/RIS server 106 and Integrated Patient Management Application 102 is established through a DICOM link 116 using the DICOM protocol—an application layer protocol used by most HIS/RIS servers. The schedule information obtained by Integrated Patient Management Application 102 from HIS/RIS server 106 is stored in a Common Database 108. Common Database 108 is implemented by using standard database management systems (DBMS) such as IBM® DB2/Common-Server, Sybase®, Oracle®, or other similar available database systems. In the preferred embodiment of the present invention, Common Database 108 is implemented as a custom flat file database. (A custom flat file database is a feature specific database in which data is stored as a sequence of values.) It would be apparent to one skilled in the art that Common Database 108 can be implemented in numerous ways without deviating from the spirit and scope of the present invention.

Integrated Patient Management Application 102 preferably comprises two modules: an Integrated Patient Scheduler 118 and an Integrated Worklist Server 120. Integrated Patient Scheduler 118 provides the user interface functionality of Integrated Patient Management Application 102. This includes functionalities such as generating a request for Integrated Worklist Server 120 for retrieval of schedules, viewing and editing information contained in Common Database 108, adding new patients in the schedule maintained in Common Database 108, deleting schedules from Common Database 108, performing preventive maintenance of Common Database 108, and adding modality specific information (for example, the contrast used for a CT scan or the tracer data for a PET scan). The preventive maintenance of Common Database 108 may involve periodically deleting old schedules or other stored data that meets certain criteria (for example, deleting all schedules for a particular patient, date range, or scan status).

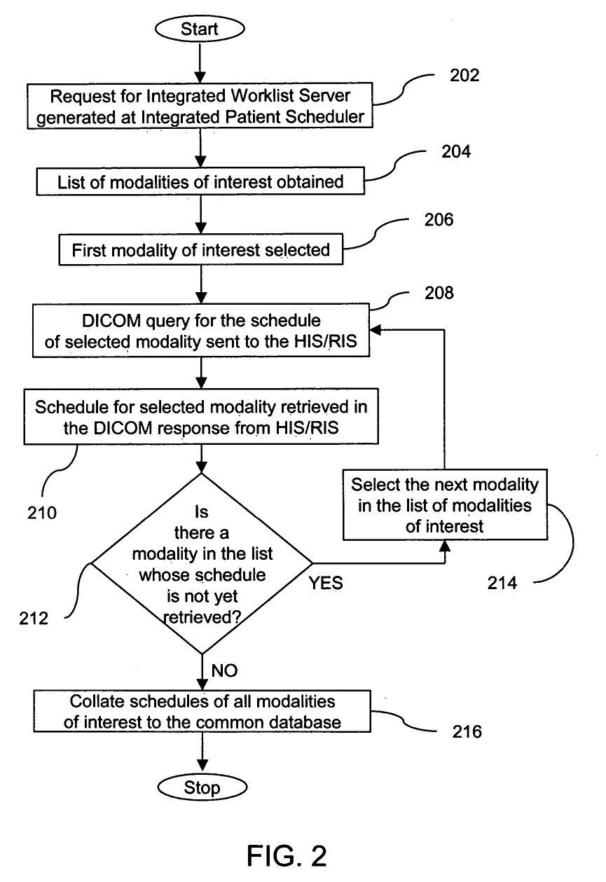

Integrated Worklist Server 120 performs the functions of a standard DICOM-compliant Service Class User (SCU). These functions preferably include sending, receiving and parsing of DICOM queries for communicating with HIS/RIS server 106. DICOM queries allow Integrated Worklist Server 120 to retrieve the schedules for a particular modality from HIS/RIS server 106. The DICOM queries also contain certain parameters that provide for further refinement of the query. This refinement can be implemented by specifying constraints like “the time period within which a schedule entry must lie” for it to be included in the DICOM query response from HIS/RIS server 106. In addition to the above, Integrated Worklist Server 120 preferably provides two important functionalities. First, Integrated Worklist Server 120 provides for the retrieving of schedules for only certain “modalities of interest” out of all the modalities of Hybrid Scanner 104. The “modalities of interest” are the modalities whose schedules are to be retrieved from HIS/RIS server 106 for updating Common Database 108. Not all the modalities of a hybrid scanner may be of interest to an operator of the Hybrid Scanner 104. For instance, consider a hybrid scanner with a CT modality, a PET modality, and an X-ray modality. Further, consider that the operator is interested in the schedules of only the CT modality and the PET modality. Then, only these two modalities are included in a set of “modalities of interest.” Integrated Worklist Server 120 stores this set in a Preferences Database (a part of Common Database 108) for use while updating Common Database 108 from HIS/RIS server 106. The operator of the Hybrid Scanner 104 specifies the set of “modalities of interest” through Integrated Patient Scheduler 118. In one embodiment of the present invention, the set is pre-specified and saved for use for all future retrievals of schedules from HIS/RIS server 106. In an alternate embodiment of the present invention, the operator of the Hybrid Scanner 104 specifies the set before each retrieval operation. In the preferred embodiment of the present invention, the operator of the Hybrid Scanner 104 is given the option either to use a pre-specified set or to specify a new set prior to a retrieval operation. A method for retrieving schedules for the modalities of interest from HIS/RIS server 106 is described in conjunction with FIG. 2.

Further, Integrated Worklist Server 120 initiates and monitors the progress of scans on the Hybrid Scanner 104 and maintains an integrated modality worklist in the common database. The maintenance of the integrated worklist in the common database includes updating the worklist using the schedule retrieved from HIS/RIS server 106. It further includes adding, editing and deleting schedule entries from the worklist using the operator's inputs from Integrated Patient Scheduler 118.

Integrated Patient Management Application 102 can be implemented using an IBM® Netfinity® server comprising a RISC-based processor, AIX.RTM, an operating system and a web server program, such as Netscape Enterprise Server. In the preferred embodiment of the present invention, Integrated Patient Management Application 102 is implemented using C++ and Java on a Solaris platform. Integrated Patient Management Application 102 may also include a display supporting a graphical user interface (GUI) for management and administration of the network. Integrated Patient Management Application 102 may additionally include an Application Programming Interface (API) that provides extensions to enable application developers to extend and/or customize the core functionality thereof through software programs, including Common Gateway Interface (CGI) programs, plug-ins, servlets, active server pages (ASPs), server side include (SSI) functions, or other similar software programs.

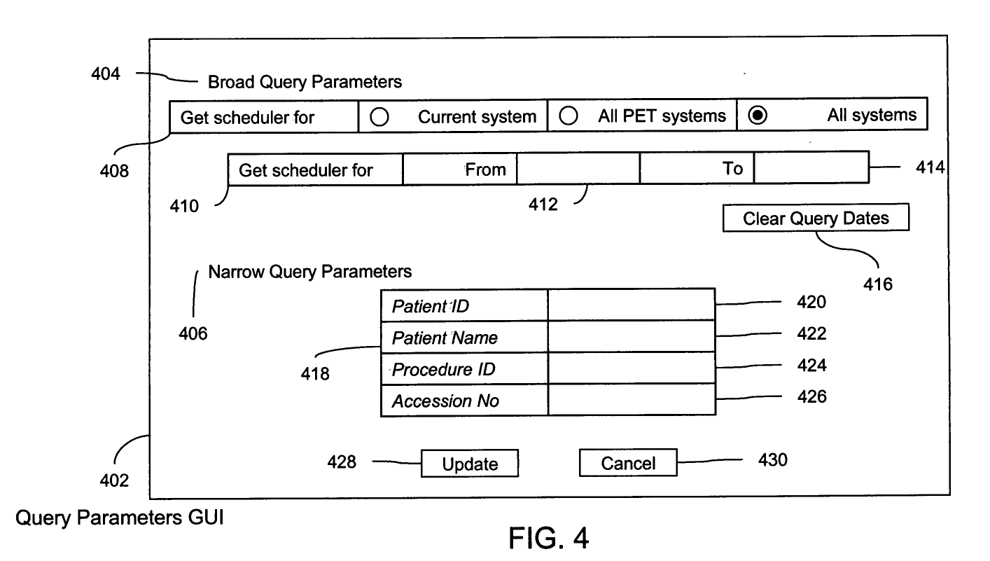

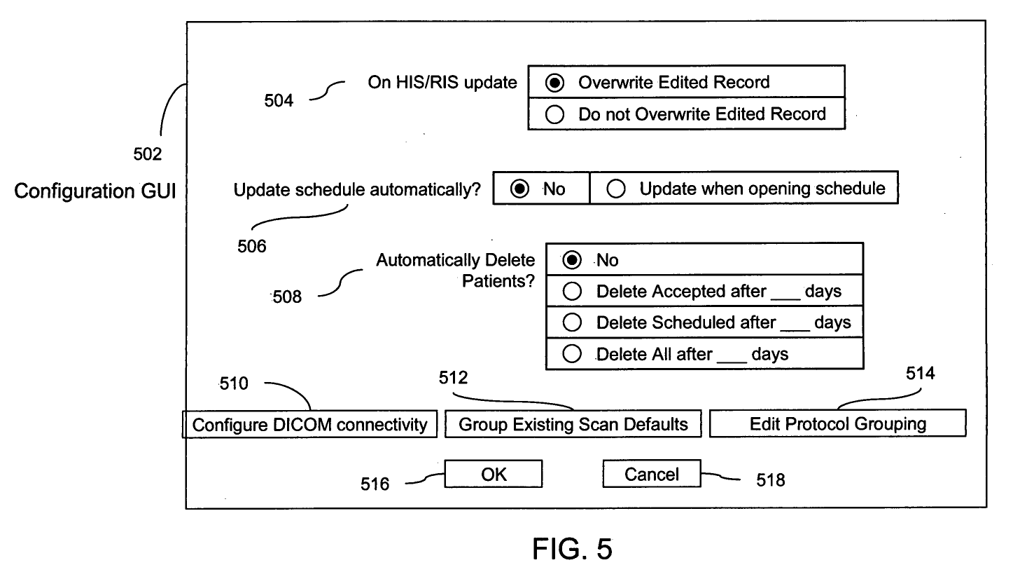

According to one embodiment of the present invention, Common Database 108 is divided in to three constituent databases: a Patient Database, a Procedure Information Database, and a Preferences Database. The Patient Database stores preferably patient related information such as the name of the patient, referring physician, date of birth, sex, height, weight and other demographic information. The Procedure Information Database preferably stores information related to the scan procedure requested such as AIC scheme, AIC value, AIC meaning, modality specified by the schedule entry, start time of the scan, end time of the scan and status of the scan (New or Complete). The Preferences Database stores certain operator-defined preferences. The operator-defined preferences include without limitation the set of “modalities of interest” described with reference to FIG. 2. Some other operator-defined preferences stored in the Preferences Database are described with reference to FIG. 4 and FIG. 5. In one embodiment of the present invention, the Preferences Database is implemented as a custom flat file database.

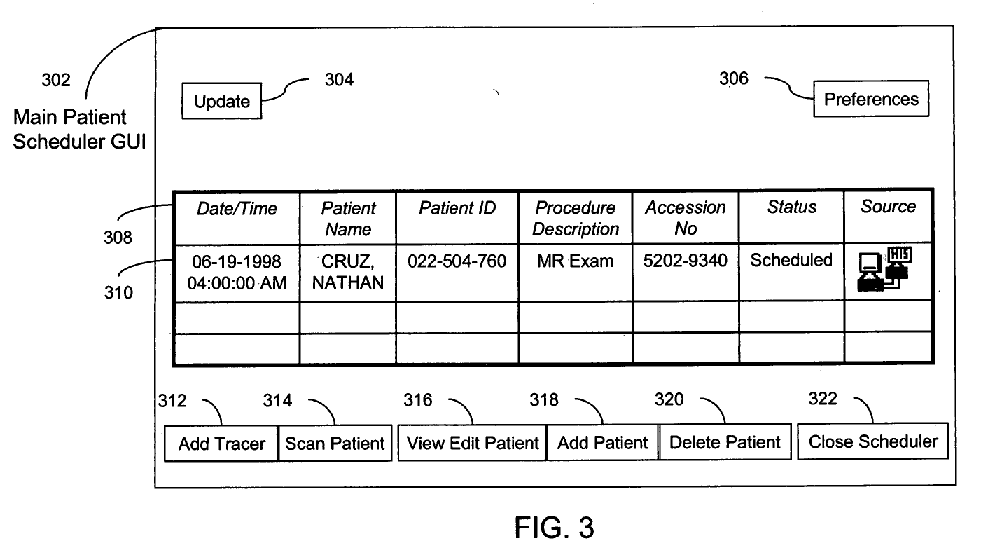

Referring now primarily to FIG. 2, the method of retrieving schedules for the modalities of interest from HIS/RIS server 106 is hereinafter described in detail. At step 202, Integrated Patient Scheduler 118 generates a request for Integrated Worklist Server 120 to initiate the retrieving of schedules. In one embodiment of the present invention, the request is generated in response to a user action. An example of such a user action is an explicit request by the operator to update the schedule. Another example of such user action is loading of the GUI by the operator to view the schedule (as described with reference to FIG. 3).

In an alternate embodiment, Integrated Patient Scheduler 118 generates the request at user-defined periodic intervals. In another alternate embodiment of the present invention, the operator has the option to choose whether the request is generated in response to a user action or it is generated automatically at user-defined periodic intervals. At step 204, Integrated Worklist Server 120 obtains the set of modalities of interest from Integrated Patient Scheduler 118. Alternately, Integrated Worklist Server 120 retrieves the pre-specified set of “modalities of interest” from the Preferences database. Then at step 206, Integrated Worklist Server 120 selects the first modality in the set of modalities of interest for retrieving its schedule. Subsequently, Integrated Worklist Server 120 executes a loop to retrieve the schedules of all modalities in the set of “modalities of interest”. At step 208, the first step of the loop, Integrated Worklist Server 120 constructs and sends a DICOM query to HIS/RIS server 106 for retrieving the schedule for the selected modality. During the first iteration of. the loop, the first modality in the set is the selected modality. At step 210, HIS/RIS server 106 sends the schedule for the selected modality in response to the DICOM query of step 208. Then at step 212, Integrated Worklist Server 120 checks if there is a modality left in the set, whose schedule has not yet been retrieved. In the case of no modality being present in the set retrieved, the Integrated Worklist Server 120 exits the loop and proceeds to step 216. In case such a modality is present in the set, then at step 214, Integrated Worklist Server 120 selects this modality for retrieving its schedule and steps 208 and 210 are repeated for the modality thus selected. Thus, the loop comprising steps 208, 210, 212 and 214 is repeated automatically by Integrated Worklist Server 120 until the schedules of all the modalities in the set have been retrieved. Once this is done, the method proceeds to step 216 where the schedules of all the modalities are collated by Integrated Worklist Server 120 and stored in Common Database 108. Thus, the requirement of operator intervention is minimized leading to an increase in operator productivity.

The present invention allows the operator of the Hybrid Scanner 104 to modify the schedule in Common Database 108 using Integrated Patient Scheduler 118. However, these modifications are not communicated to HIS/RIS server 106. Thus, in subsequent retrievals of the schedule from HIS/RIS server 106, there is a possibility of a mismatch between the schedule present in the Common Database 108 and the schedule retrieved from HIS/RIS 106. In case of a mismatch, Integrated Worklist Server 120 has at least two options. According to the first option, Integrated Worklist Server 120 can update the schedule entry in Common Database 108 using the newly retrieved schedule entry in the collated schedule. Alternatively, according to the second option, Integrated Worklist Server 120 can retain the schedule entry of Common Database 108. One of the above options is selected by Integrated Worklist Server 120 based on the operator's preference. A GUI allowing the operator to define this preference has been described with reference to FIG. 5.

Referring now primarily to FIG. 3, a graphical user interface (GUI) provided by Integrated Patient Scheduler 118 for the viewing and editing Common Database 108 and for configuring Integrated Patient Scheduler 118 is hereinafter described. The figure shows a Main Patient Scheduler GUI 302. Main Patient Scheduler GUI 302 has an Update Button 304 to allow the operator to explicitly request the retrieving of schedules of the modalities of interest from HIS/RIS server 106. The figure also shows a Preferences Button 306 for loading a GUI to edit the user-defined preferences that control the retrieval of schedules. The controlling can be implemented by retrieving only the schedule entries that meet the criteria specified in these preferences. Some examples of such criteria are “the time range within which a schedule entry must lie”, or “the modality of the schedule entry” (See FIG. 4). The figure also shows a Schedule Display 308 to display the schedule obtained from Common Database 108. Schedule Display 308 has seven columns. The first column, a Date/Time column displays the date and time of the schedule entry. A Patient Name column displays the name of the patient on whom the scan is to be performed. A Patient ID column displays the identification number assigned to the patient. Schedule Display 308 further has a Procedure Description column to display a brief textual description of the requested scan, and an Accession Number column to display an accession number corresponding to a schedule entry. The accession number is an identifier specified by DICOM to uniquely identify a particular schedule entry. Schedule Display 308 also has a Status column to display the current status of the schedule entry. The status is one of the following: Scan completed and Scan not completed (or Scheduled). The Scan completed/Scan not completed status indicates if a particular scan has been successfully performed by the scanner or not. Common Database 108 further stores an Edited/Not Edited status, indicating whether the schedule entry has been edited locally at the scanner using Integrated Patient Scheduler 118 or not. This status is not displayed on the GUI but is used by Integrated Patient Management Application 102 when Common Database 108 is updated using the schedule downloaded from HIS/RIS server 106. In case of a mismatch between the schedule entry stored in Common Database 108 and the one retrieved from HIS/RIS server 106, Integrated Patient Management Application 102 selects one of these two based on the operators preference (which can be set by the operator using a Preferences GUI as described with reference to FIG. 5). This mismatch can arise if a schedule entry is edited locally at Hybrid Scanner 104. If such an editing is performed, the Edited/Not Edited status is set to indicate the same. This status is used to locate mismatches between schedule entries stored in Common Database 108 and the ones retrieved from HIS/RIS server 106. Finally, Schedule Display 308 has a Source column to display an icon designating the source from which the particular schedule entry has been obtained. One source from which a particular schedule entry is obtained is HIS/RIS server 106. Additionally, a new schedule entry can be entered by the operator of the Hybrid Scanner 104 using Integrated Patient Scheduler 118. A schedule entry obtained from Integrated Patient Scheduler 118 is known as a local schedule.

The figure also shows a Sample Schedule Entry 310 to illustrate with an example the data displayed by Schedule Display 308. Sample Schedule Entry 310 shows a request for a Magnetic Resonance (MR) exam. The request is scheduled for date “06-19-1998” at time “04:00:00 AM” as shown in the Date/Time column. The patient name is displayed in the Patient Name column entry, such as “CRUZ, NATHAN”, as shown in FIG. 3. The identification number assigned to this patient is displayed in the Patient ID column as “022-504-760”, and the Procedure Description column identifies the requested procedure as an “MR Exam”. The Accession Number column displays the accession number of the request to be 5202-9340. The Status column shows that the test is yet to be performed, by indicating the status as “Scheduled”. Finally, the Source column is shown with an icon indicating that this request has been obtained from HIS/RIS server 106.

Schedule Display 308 shows all schedule entries present in Common Database 108. It also allows the operator to select a particular schedule entry. This allows the operator to specify the schedule entry for performing the actions associated with a set of schedule entry specific buttons of Main Patient Scheduler GUI 302. The actions associated with these buttons of Main Patient Scheduler GUI 302 are described hereinafter.

In an exemplary embodiment of this invention, the first schedule entry specific button of Main Patient Scheduler GUI 302 is an Add Tracer Button 312. Add Tracer Button 312 loads a Tracer GUI. The Tracer GUI allows the operator to edit PET scan related tracer information like batch description, pre-injection activity with its date/time, post-injection activity with its date/time, injection date & time, and injection activity. Next to Add Tracer Button 312 is a Scan Patient Button 314 for performing the scan specified by the schedule entry selected in Schedule Display 308. Further, Main Patient Scheduler GUI 302 also provides functionality to access a Patient Database. A View Edit Patient Button 316 launches a GUI that allows the operator to view the patient information stored in the Patient database. An Add Patient Button 318 allows the operator to add a new patient to the Patient database, and a Delete Patient Button 320 allows the operator to delete an existing patient from the Patient database. Finally, a Close Scheduler Button 322 allows the operator to close and unload Main Patient Scheduler GUI 302.

Referring now primarily to FIG. 4, a GUI to edit the user-defined preferences that control the retrieval of schedules from HIS/RIS server 106, a Query Filter GUI 402 is hereinafter described. Query Parameters GUI 402 gives the flexibility for the operator to specify certain parameters that are used to construct a DICOM query by Integrated Worklist Server 120. Query Parameters GUI 402 is loaded before the generation of each DICOM query by Integrated Worklist Server 120. Alternatively, the loading of this GUI before every query can be turned off using the Preferences GUI (described with reference to FIG. 5).

The figure shows a Query Parameters GUI 402 having a Broad Query Parameters section 404 and a Narrow Query Parameters section 406. The broad query parameters allow the operator to select the schedule entries based on the modality of the schedule entry and the date/time of the schedule entry. Broad Query Parameters section 404 has a System Selector 408 that allows the operator to select the systems for which schedules must be retrieved. The figure shows three options for the operator, presented as three radio buttons on the GUI. The first radio button corresponds to the option of retrieving the schedules for the Hybrid Scanner 104 attached to the system on which Integrated Patient Management Application 102 is loaded. The second radio button corresponds to the option of retrieving the schedules for all scanners having a PET modality. The third radio button corresponds to the option of retrieving the schedules for all scanners in the hospital network that are connected to HIS/RIS server 106. This option is useful in hospitals having multiple scanners where a scan scheduled on a particular scanner can be assigned to another scanner. Such an assignment may be necessary in case a scanner goes out-of-order, or develops a problem such as the malfunctioning of its detector or pin source.

Broad Query Parameters 404 also has a Time Range Selector 410 for specifying the time range for which schedules must be retrieved. Thus, HIS/RIS server 106 includes only the schedule entries that lie within the specified time range in response to the DICOM query. Time Range Selector 410 has a “From” date selector 412 and a “To” date selector 414, for specifying the start and end dates of the time range respectively. Further, Broad Query Parameters 404 also has a Clear Query Dates Button 416 to remove any previously specified dates in “From” date selector 412 and “To” date selector 414.

Narrow Query Parameters 406 contains an information entry table 418 having four entry boxes to allow the operator to define parameters to further narrow the scope of the DICOM query generated by Integrated Worklist Server 120. A Patient ID Field 420 allows the operator to restrict the scope of the DICOM query to a particular patient, thereby facilitating the viewing of all schedule entries for that patient. A Patient Name Field 422 allows the operator to specify the name of the patient whose schedule entries are to be retrieved. A Procedure ID Field 424 allows the operator to specify the procedure ID of the schedule entries to be retrieved. This procedure ID corresponds to the Requested Procedure ID field specified by DICOM. Finally, an Accession Number Field 426 allows the operator to specify the Accession Number of the schedule entries to be retrieved. One or more of these entry boxes can be checked by the operator to narrow the scope of the DICOM query.

Finally, Query Parameters GUI 402 has an Update Button 428 to accept and store the parameters input by the operator in the GUI in the Preferences Database, and a Cancel Button 430 to unload Query Parameters GUI 402 without accepting the changes made to any of the parameters in the GUI.

Referring now primarily to FIG. 5, a GUI for the configuration of Integrated Patient Management Application 102 is hereinafter described. The figure shows a Configuration GUI 502 having an Overwrite Mode Selector 504. Overwrite Mode Selector 504 allows the operator to choose if a schedule entry modified at the scanner can be overwritten by a new schedule entry retrieved from HIS/RIS server 106. The new schedule entry is retrieved from HIS/RIS server 106 in response to a subsequent DICOM query generated by Integrated Worklist server 120. The first radio button option “Overwrite Edited Record” causes Integrated Worklist server 120 to overwrite the schedule entries in Common Database 108 with the schedule entry retrieved from HIS/RIS server 106 if both the new and the old schedule entries are for the same patient. The second radio button option “Do not Overwrite Edited Record” disables this option, and retains the changes made to the schedule entry at the scanner across subsequent queries. An Automatic Schedule Update Selector 506 allows the operator to decide when Integrated Patient Scheduler 118 generates a request for the retrieval of schedules. Further, Configuration GUI 502 has a Delete Operation Controller 508 that allows the operator to configure the manner in which schedule entries are deleted from Common Database 108. The first option, “No”, of Delete Operation Controller 508 disables the auto-delete functionality. The second option, “Delete Accepted after_days”, allows the operator to define the number of days after which Integrated Patient Management Application 102 deletes the schedule entries with Status “Scan Completed”. The third option, “Delete Scheduled after_days”, allows the operator to specify the number of days after which Integrated Patient Management Application 102 deletes the schedule entries with status “Scan Not Completed”. The fourth option, “Delete All after_days”, allows the operator to specify the number of days after which Integrated Patient Management Application 102 deletes the schedule, irrespective of their status.

Configuration GUI 502 further has a Configure DICOM Connectivity Button 510, a Group Existing Scan Defaults Button 512, and an Edit Protocol Grouping Button 514. Configure DICOM Connectivity Button 510 loads a GUI to configure the DICOM connectivity options like the Port number, the Service Class Provider (SCP) Application Entity title and the IP address of HIS/RIS server 106. Group Existing Scan Defaults Button 512 loads a GUI for creating protocol group to Action Item Code mapping. Edit Protocol Grouping Button 514 loads another GUI to re-assign protocol groups to Action Item Codes by editing existing protocol group to Action Item Code mappings.

Finally, Configuration GUI 502 has an OK Button 516 to accept and store the parameters input by the operator in the GUI and a Cancel Button 518 to unload Configuration GUI 502 without accepting the changes made to any of the parameters in the GUI.

An advantage of the present invention is that it leads to improved operator productivity as the schedules for multiple modalities are retrieved from HIS/RIS server 106 automatically with a single user action. Further, the present invention eliminates the need for maintenance of multiple databases to store the schedules for a Hybrid Scanner 104, thus leading to improved data integrity and error proofing.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

Throughout the specification, numerous advantages of exemplary embodiments have been identified. It will be understood of course that it is possible to employ the teachings herein so as to without necessarily achieving the same advantages. Additionally, although many features have been described in the context of computer servers and patient scheduling software, it will be appreciated that such features could also be implemented in the context of other software configurations. It will be apparent to one skilled in the art that the GUIs shown in the above figures are exemplary and the same should not be construed as limiting.

Further, although the figures depict a series of steps that are performed sequentially, the steps shown in such figures generally need not be performed in any particular order. Additionally, some steps shown may be performed repetitively with particular ones of the steps being performed more frequently than others. Alternatively, it may be desirable in some situations to perform steps in a different order than shown. Many other changes and modifications may be made to the present invention without departing from the spirit thereof.

1. A method for managing the modality worklist for a hybrid scanner comprising the steps of:
a. retrieving the schedule of the first modality in the set of modalities of interest from the HIS/RIS server;
b. confirming whether there are additional modalities in the list to be retrieved;
c. repeating the process for retrieval of modality schedules, automatically, for all modalities in the set of modalities of interest, until all schedules have been retrieved; and
d. collating all the retrieved schedules to obtain an integrated modality worklist for the modalities of interest;
wherein the modality worklist consists of schedule information of a set of modalities of interest in the hybrid scanner.

2. The method as recited in claim 1 wherein the step of retrieving the schedule information of a modality of interest from the HIS/RIS server comprises:
a. sending a DICOM request for the schedule information to the HIS/RIS server; and
b. receiving the schedule information from the HIS/RIS server in a DICOM compliant format.

3. A method for managing the modality worklist for a hybrid scanner comprising the steps of:
a. generating a request for retrieval of schedule information;
b. obtaining the list of modalities of interest;
c. retrieving the schedule information of the first modality in the set of modalities of interest from the HIS/RIS server;
d. confirming whether there are additional modalities in the list to be retrieved;
e. repeating the process for retrieval of modality schedules, automatically, for all modalities in the set of modalities of interest, until all schedules have been retrieved; and
f. collating all the retrieved schedules to obtain an integrated modality worklist for the modalities of interest;
wherein the modality worklist consists of schedule information of a set of modalities of interest in the hybrid scanner and the schedule information of the modalities of interest is retrieved from a HIS/RIS server.

4. The method as recited in claim 3 wherein the step of generating a request is performed in response to a user action.

5. The method as recited in claim 3 wherein the step of generating a request is performed at user-defined periodic intervals.

6. The method as recited in claim 3 wherein an option exists for a user to choose whether the request is generated in response to a user action or it is generated automatically at user-defined periodic intervals.

7. The method as recited in claim 3 wherein the retrieved schedules of the modalities are stored in a database.

8. A system for managing the modality worklist for a hybrid scanner comprising:
a. a hybrid scanner consisting of a combination of two or more modalities for performing scans with single or hybrid modalities;
b. an integrated patient management application retrieving the schedule information of the modalities of interest from the HIS/RIS server; and
c. a common database collating all the schedule information retrieved by the integrated patient management application to obtain an integrated modality worklist;
wherein the modality worklist consists of schedule information of a set of modalities of interest in the hybrid scanner and the schedule information of the modalities of interest is retrieved from a HIS/RIS server.

9. The system as recited in claim 8 wherein the set of modalities of interest is pre-specified for all retrievals of schedule information from HIS/RIS server.

10. The system as recited in claim 8 wherein the set of modalities of interest is specified by an operator of the hybrid scanner prior to the retrieval of schedule information from HIS/RIS server.

11. The system as recited in claim 8 wherein the integrated worklist server retrieves schedules for only certain modalities of interest out of all the modalities of the hybrid scanner.

12. The system as recited in claim 11 wherein the integrated worklist server stores the selected modalities of interest in a preferences database section within the common database.

13. The system as recited in claim 8 wherein the integrated patient management application comprises:
a. an integrated patient scheduler, providing the user-interface functionality of the integrated patient management application; and
b. an integrated worklist server, initiating and monitoring scans on the hybrid scanner, retrieving schedule information from the HIS/RIS server, and maintaining an integrated modality worklist in the common database.

14. The system as recited in claim 8 wherein the communication between the modalities of the hybrid scanner and the integrated patient management application is established through an implementation dependent link.

15. The system as recited in claim 14 wherein communication implementation dependent link is a TCP/IP socket based communication or other similar communication links.

16. The system as recited in claim 8 wherein the communication between the HIS/RIS server and the integrated patient management application is established through a communication link, using DICOM protocol or other similar communication protocol.

17. The system as recited in claim 8 wherein the integrated patient scheduler generates requests to the integrated worklist server for retrieval of schedules.

18. The system as recited in claim 8 wherein the integrated patient scheduler enables viewing and altering of information contained in a common database.

19. The system as recited in claim 8 wherein the common database further comprises:
a. a patient database storing patient related information;
b. a procedure information database storing information related to the scan procedure requested; and
c. a preferences database storing configuration preferences for the integrated patient management application.

20. The system as recited in claim 8 wherein the common database is implemented using a custom flat file database.
